(19) United States
(12) Patent Application Publication
(10) Pub. No.: US 2025/0178592 A1
(43) Pub. Date: Jun. 5, 2025

(54) CONTROL DEVICE, CONTROL METHOD, AND CONTROL PROGRAM

(71) Applicant: HONDA MOTOR CO., LTD., Tokyo (JP)

(72) Inventors: Gaku SHIMAMOTO, Tokyo (JP); Junpei NOGUCHI, Tokyo (JP)

(73) Assignee: HONDA MOTOR CO., LTD., Tokyo (JP)

(21) Appl. No.: 18/843,715

(22) PCT Filed: Mar. 4, 2022
(86) PCT No.: PCT/JP2022/009500

§ 371 Date: Sep. 4, 2024

(51) Int. Cl. B60W 30/06; B60W 10/30; B60W 50/14; E05F 15/77

(52) U.S. Cl. CPC B60W 30/06; B60W 50/14; E05F 15/77; B60W 10/30; B60W 2520/04; E05Y 2900/546

(57) ABSTRACT

A control device for a moving object that includes an opening and closing body includes: a control unit configured to perform automated movement control for moving the moving object to a target movement position that is a parking position or a exit position. In response to an opening and closing reservation of the opening and closing body being performed, the control unit stops the moving object at an opening and closing position different from the target movement position after the automated movement control is started, performs opening and closing of the opening and closing body, and resumes movement of the moving object toward the target movement position after the opening and closing are completed.

### TECHNICAL FIELD

The present invention relates to a control device, a control method, and a control program.

### BACKGROUND ART

In recent years, improvement in traffic safety has been required in order to enable inclusion, safety, toughness, and sustainability of urban and human settlements. In a vehicle, from the viewpoint of improving traffic safety, for example, it is required to ensure traffic safety even when an abnormality occurs in the vehicle.

There has been known, so far, a remote parking system that remotely operates a vehicle to park the vehicle in a specified predetermined parking space or to cause the vehicle to exit from the parking space. Patent Literature 1 discloses a parking assistance device that starts automated parking of a vehicle when at least one of a motion and voice matching a parking instruction action by a user is detected. Patent Literature 2 discloses a vehicle remote operation system that determines an exit position of a vehicle based on a parking position of the vehicle and a position of an occupant who plans to get on the vehicle.

### CITATION LIST

### Patent Literature

Patent Literature 1: JP2019-164444A
Patent Literature 2: WO2011/128965

### SUMMARY OF INVENTION

### Technical Problem

According to the parking assistance device in Patent Literature 1, automated parking control of the vehicle can be started based on the parking instruction action of the user, and thus the automated parking control can be performed in which the user does not need to take out an operation terminal remotely and perform a predetermined operation. According to the vehicle remote control system in Patent Literature 2, it is possible to cause the vehicle to exit to a predetermined position according to the parking position of the vehicle and the position of the occupant, and it is possible to improve convenience of an exiting operation and getting on the vehicle. However, in either case, it cannot be said that it is always sufficient to improve convenience of automated parking and automated exiting of the vehicle, and there is room for further improvement in relation to control of the automated parking and the automated exiting of the vehicle.

An object of the present invention is to provide a control device, a control method, and a control program that may perform appropriate movement control on a moving object in order to perform opening and closing of an opening and closing body of the moving object.

### Solution to Problem

The present invention provides
a control device for a moving object that includes an opening and closing body, the control device including:
a control unit configured to perform movement control for moving the moving object to a target movement position, in which,
in response to an opening and closing reservation of the opening and closing body is performed, the control unit stops the moving object at an opening and closing position different from the target movement position after the movement control is started, performs opening and closing of the opening and closing body, and resumes movement of the moving object toward the target movement position after the opening and closing are completed.

The present invention provides
a control method including:
causing a processor of a control device that performs movement control for moving a moving object including an opening and closing body to a target movement position to stop, in response to an opening and closing reservation of the opening and closing body being performed, the moving object at an opening and closing position different from the target movement position after the movement control is started, perform opening and closing of the opening and closing body, and resume movement of the moving object toward the target movement position after the opening and closing are completed.

The present invention provides
a control program causing a processor of a control device that performs movement control for moving a moving object including an opening and closing body to a target movement position to execute processing of
stopping, in response to an opening and closing reservation of the opening and closing body being performed, the moving object at an opening and closing position different from the target movement position after the movement control is started, performing opening and closing of the opening and closing body, and resuming movement of the moving object toward the target movement position after the opening and closing are completed.

### Advantageous Effects of Invention

According to the present invention, it is possible to provide a control device, a control method, and a control program that may perform appropriate movement control on a moving object in order to perform opening and closing of an opening and closing body of the moving object.

### BRIEF DESCRIPTION OF DRAWINGS

FIG. 1 is a side view showing an example of a vehicle subjected to movement control by a control device, a control method, and a control program according to an embodiment;

FIG. 2 is a top view of the vehicle shown in FIG. 1;

FIG. 3 is a block diagram showing an internal configuration of the vehicle shown in FIG. 1;

FIG. 4 shows an example of a hardware configuration of an information terminal;

FIG. 5 shows a part of a state in which the vehicle is caused to perform automated parking at a predetermined parking position using the information terminal;

FIG. 6 shows a part of the state in which the vehicle is caused to perform automated parking at the predetermined parking position using the information terminal;

FIG. 7 shows a part of the state in which the vehicle is caused to perform automated parking at the predetermined parking position using the information terminal;

FIG. 8 shows a part of the state in which the vehicle is caused to perform automated parking at the predetermined parking position using the information terminal;

FIG. 9 shows a part of the state in which the vehicle is caused to perform automated parking at the predetermined parking position using the information terminal;

FIG. 10 is a flowchart showing parking instruction control of the vehicle by the information terminal;

FIG. 11 is a flowchart showing the parking instruction control of the vehicle by the information terminal;

FIG. 12 shows an example of a child lock screen displayed on the information terminal;

FIG. 13 shows an example of a disclaimer notification and agreement screen displayed on the information terminal;

FIG. 14 shows an example of a connection screen with the vehicle displayed on the information terminal;

FIG. 15 shows an example of an alighting guide screen displayed on the information terminal;

FIG. 16 shows an example of a first action plan screen displayed on the information terminal;

FIG. 17 shows an example of a second action plan screen displayed on the information terminal;

FIG. 18 shows an example of an operation input start screen displayed on the information terminal;

FIG. 19 shows an example of an operation input screen displayed on the information terminal;

FIG. 20 shows an example of an opening and closing screen displayed on the information terminal;

FIG. 21 shows an example of the opening and closing screen displayed on the information terminal; and

FIG. 22 shows an example of an automated parking completion screen displayed on the information terminal.

### DESCRIPTION OF EMBODIMENTS

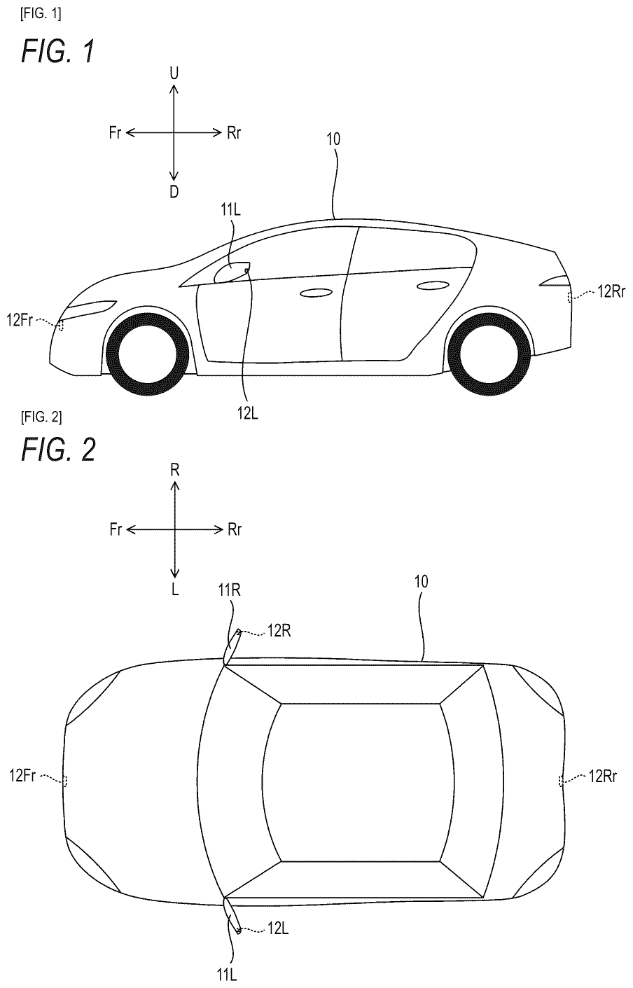

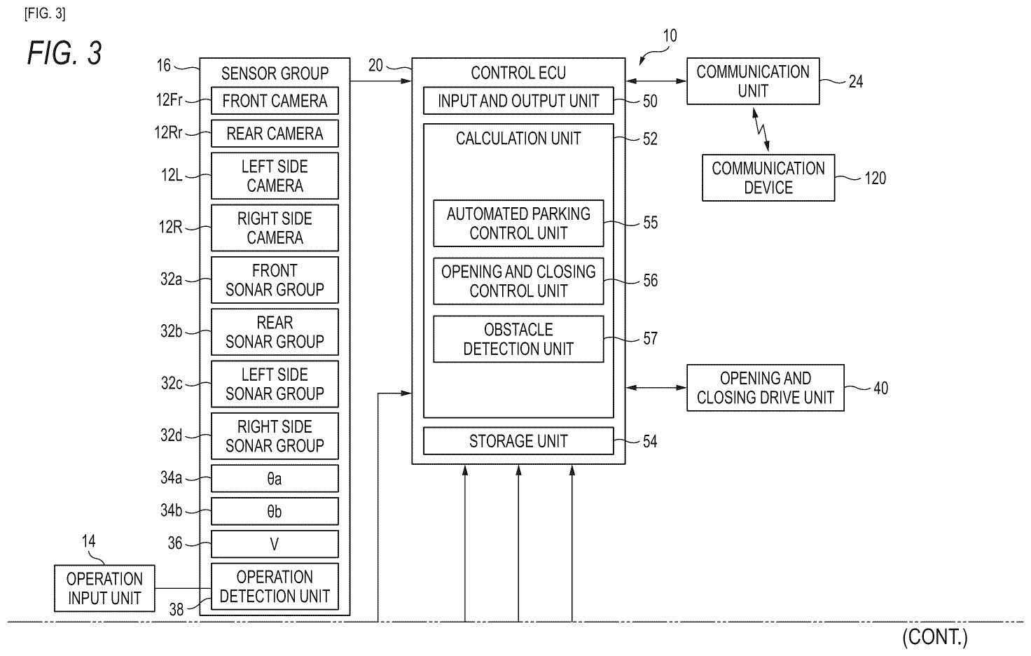

Hereinafter, an embodiment of a control device, a control method, and a control program of the present invention will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### <Vehicle 10 Subjected to Movement Control by Control Device of Present Invention>

FIG. 1 is a side view of the vehicle 10 subjected to movement control by the control device of the present invention. FIG. 2 is a top view of the vehicle 10 shown in FIG. 1. The vehicle 10 is an example of a moving object of the present invention.

The vehicle 10 is an automobile including a drive source (not shown) and wheels including drive wheels driven by power of the drive source and steerable steered wheels. In the present embodiment, the vehicle 10 is a four-wheeled automobile having a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is a digital camera that is provided on the front side of the vehicle 10 and captures an image of the front side of the vehicle 10. The rear camera 12Rr is a digital camera that is provided on the rear side of the vehicle 10 and captures an image of the rear side of the vehicle 10. The left side camera 12L is a digital camera that is provided on the left side mirror 11L of the vehicle 10 and captures an image of the left side of the vehicle 10. The right side camera 12R is a digital camera that is provided on the right side mirror 11R of the vehicle 10 and captures an image of the right side of the vehicle 10.

### <Internal Configuration of Vehicle 10>

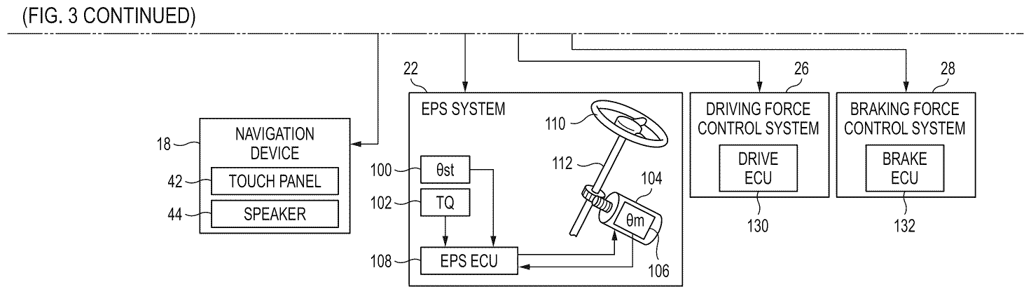

FIG. 3 is a block diagram showing an example of an internal configuration of the vehicle 10 shown in FIG. 1. As shown in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26, a braking force control system 28, and an opening and closing drive unit 40.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire recognition data (for example, peripheral images) for recognizing an external environment of the vehicle 10 by capturing images of a periphery of the vehicle 10. The peripheral images captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a countershaft of a transmission.

The operation detection unit 38 detects an operation content of a user performed using an operation input unit 14, and outputs the detected operation content to the control ECU 20. The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 using, for example, a global positioning system (GPS), and guides the user along a route to a destination. The navigation device 18 includes a storage device (not shown) including a map information database.

The navigation device 18 includes a touch panel 42 and a speaker 44. The touch panel 42 functions as an input device and a display device of the control ECU 20. The speaker 44 outputs various types of guidance information to the user of the vehicle 10 by voice. The touch panel 42 is configured such that input of various commands to the control ECU 20 can be input via the touch panel 42. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes an automated parking button for requesting parking by automatic steering of the control ECU 20, and a support parking button for requesting support while parking the vehicle by an operation of the driver. The exiting assistance button includes an automated exiting button for requesting exiting by the automatic steering of the control ECU 20, and a support exiting button for requesting support while exiting by an operation of the driver. Components other than the touch panel 42, for example, a smartphone or a tablet terminal may also be used as the input device or the display device.

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. Further, the calculation unit 52 receives and outputs signals from and to units connected to the control ECU 20 via the input and output unit 50.

The calculation unit 52 includes an automated parking control unit 55 that performs movement execution control of the vehicle 10, an opening and closing control unit 56 that performs opening and closing control of an opening and closing body of the vehicle 10, and an obstacle detection unit 57 that detects an obstacle when the vehicle 10 performs parking or exiting.

The automated parking control unit 55 performs automated parking assistance and automated exiting assistance of the vehicle 10 by automatic steering in which a steering 110 is automatically operated under control of the automated parking control unit 55. In the automated parking assistance and the automated exiting assistance, an accelerator pedal (not shown), a brake pedal (not shown), and the operation input unit 14 are automatically operated. The automated parking control unit 55 performs auxiliary parking assistance and auxiliary exiting assistance when the driver operates the accelerator pedal, the brake pedal, and the operation input unit 14 to perform manual parking and manual exiting of the vehicle 10.

For example, based on the recognition data of the external environment of the vehicle 10 acquired by the front camera 12Fr, the rear camera 12Rr, the left side camera 12L, and the right side camera 12R, and a parking space specified by the user, the automated parking control unit 55 performs execution control of automated parking for causing the vehicle 10 to park in the predetermined parking space. Based on the recognition data of the external environment of the vehicle 10 and an exiting space specified by the user, the automated parking control unit 55 performs execution control of automated exiting for causing the vehicle 10 to exit to the predetermined exiting space. Specifically, the automated parking control unit 55 detects features related to the parking space and the exiting space specified by the user. The automated parking control unit 55 performs the execution control of the automated parking for causing the vehicle 10 to park in the predetermined parking space based on the recognition data of the external environment of the vehicle 10 and the feature of the parking space specified by the user. The automated parking control unit 55 performs the execution control of the automated exiting for causing the vehicle 10 to exit to the predetermined exiting space based on the recognition data of the external environment of the vehicle 10 and the feature of the exiting space specified by the user.

The automated parking control unit 55 calculates an appropriate opening and closing position as a position at which the opening and closing body of the vehicle 10 is opened and closed. Examples of the opening and closing body of the vehicle 10 include a tail gate, a slide door, and a hinge door. The appropriate opening and closing position of the opening and closing body refers to, for example when the opening and closing body is a tail gate, a position at which the tail gate may be smoothly opened and closed when luggage is unloaded from a rear luggage compartment or when the luggage is loaded into the rear luggage compartment. When the opening and closing body is a slide door, the appropriate opening and closing position of the opening and closing body refers to, for example, a position at which the user may smoothly get on and off when the slide door is opened. When the opening and closing body is a hinge door, the appropriate opening and closing position of the opening and closing body refers to, for example, a position at which the user may smoothly open and close the hinge door when getting on and off the vehicle 10, and a position at which the user may smoothly get on and off when the hinge door is opened. The automated parking control unit 55 calculates the appropriate opening and closing position of the opening and closing body based on a target movement position of the vehicle 10 and the recognition data of the external environment of the vehicle 10 when the vehicle 10 performs automated parking and automated exiting. The target movement position of the vehicle 10 is a target parking position and a target exit position. The recognition data of the external environment of the vehicle 10 includes, for example, an obstacle such as a wall, a column, another vehicle, and a person located around the vehicle 10. When it is detected that there is an obstacle around the target parking position and the target exit position of the vehicle 10 when the vehicle 10 performs automated parking and automated exiting, the automated parking control unit 55 calculates the appropriate opening and closing position for the opening and closing body with respect to the obstacle that is present. The opening and closing position is a position midway along a route to the target movement position. The position midway along the route may be a position before the vehicle 10 reaches the target movement position or may be a position after passing the target movement position. The automated parking control unit 55 performs the execution control of the automated parking and the automated exiting and calculation processing of the opening and closing position of the opening and closing body based on an instruction signal received from the outside (an information terminal to be described later) via the input and output unit 50. The automated parking control unit 55 transmits information about the execution control and the calculation processing to the external information terminal via the input and output unit 50.

The opening and closing control unit 56 performs opening and closing control for automatically opening and closing the opening and closing body such as a tail gate, a slide door, and a hinge door of the vehicle 10. The opening and closing control unit 56 performs the opening and closing control of the opening and closing body based on the instruction signal received from the outside via the input and output unit 50.

The obstacle detection unit 57 detects an obstacle located around the vehicle 10. For example, the obstacle detection unit 57 detects whether there is any obstacle around the target parking position and the target exit position of the vehicle 10 when the vehicle 10 performs automated parking and automated exiting. As described above, examples of the obstacle include a wall, a column, another vehicle, and a person.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for an occupant's operation on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not shown), a calculation unit (not shown), and a storage unit (not shown).

The communication unit 24 enables wireless communication with another communication device 120. The other communication device 120 is a base station, a communication device of another vehicle, or an information terminal such as a smartphone or a tablet terminal carried by the user of the vehicle 10. The information terminal such as a smartphone or a tablet is an example of the control device of the present application.

The driving force control system 26 includes a drive ECU 130. The driving force control system 26 executes driving force control of the vehicle 10. The drive ECU 130 controls a driving force of the vehicle 10 by controlling an engine (not shown) or the like based on an operation by the user on an accelerator pedal (not shown).

The braking force control system 28 includes a brake ECU 132. The braking force control system 28 executes braking force control of the vehicle 10. The braking ECU 132 controls a braking force of the vehicle 10 by controlling a brake mechanism or the like (not shown) based on an operation by the user on a brake pedal (not shown).

The opening and closing drive unit 40 is an actuator that drives the opening and closing body such as a tail gate, a slide door, and a hinge door of the vehicle 10. The opening and closing drive unit 40 receives an opening and closing control signal from the opening and closing control unit 56 and drives the opening and closing body of the vehicle 10 based on the received opening and closing control signal.

### <Hardware Configuration of Information Terminal>

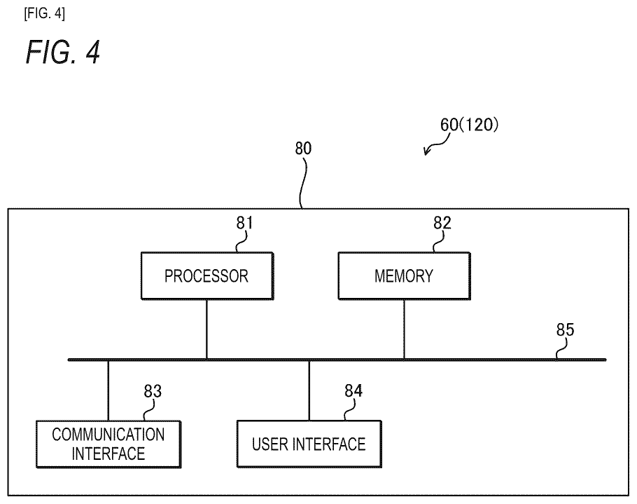

FIG. 4 shows an example of a hardware configuration of an information terminal 60. Hardware of the information terminal 60 may be implemented by, for example, an information processing device 80 shown in FIG. 4. The information processing device 80 includes a processor 81, a memory 82, a communication interface 83, and a user interface 84. The processor 81, the memory 82, the communication interface 83, and the user interface 84 are connected by, for example, a bus 85.

The processor 81 is circuitry that performs signal processing, and is, for example, a central processing unit (CPU) that controls the entire information processing device 80. The processor 81 is an example of the control unit of the present invention. The processor 81 may be implemented by another digital circuit such as a field programmable gate array (FPGA) or a digital signal processor (DSP). The processor 81 may also be implemented by combining a plurality of digital circuits.

The memory 82 includes, for example, a main memory and an auxiliary memory. The main memory is, for example, a random access memory (RAM). The main memory is used as a work area of the processor 81.

The auxiliary memory is a non-volatile memory such as a magnetic disk, an optical disk, or a flash memory. The auxiliary memory stores various programs for operating the information processing device 80. The programs stored in the auxiliary memory are loaded into the main memory and executed by the processor 81.

The auxiliary memory may include a portable memory removable from the information processing device 80. Examples of the portable memory include a universal serial bus (USB) flash drive, a memory card such as a secure digital (SD) memory card, and an external hard disk drive.

The communication interface 83 is a communication interface that performs wireless communication with the outside of the information processing device 80 (for example, the communication unit 24 of the vehicle 10). The communication interface 83 is controlled by the processor 81.

The user interface 84 includes, for example, an input device that receives an operation input from the user and an output device that outputs information to the user. The input device may be implemented by, for example, a touch panel. The output device may be implemented by, for example, a display and a speaker. The user interface 84 is controlled by the processor 81.

For example, the processor 81 performs movement instruction control for instructing movement of the vehicle 10. Specifically, the processor 81 performs the movement instruction control of the vehicle 10 based on an operation of the user on a terminal screen of the information terminal 60. The movement instruction control includes, for example, parking instruction control for causing the vehicle 10 to perform automated parking at the predetermined parking position and exiting instruction control for causing the vehicle 10 to perform automated exiting to the predetermined exit position. An application software to perform movement control on the vehicle 10 by transmitting and receiving information about the movement control of the vehicle 10 to and from the vehicle 10 is installed in the information terminal 60. When the user touches the terminal screen implemented as a touch panel, the processor 81 transmits the instruction signal for instructing automated parking and automated exiting of the vehicle 10 to the vehicle 10 by wireless communication. As the wireless communication, for example, Bluetooth low energy (BLE: registered trademark) is used.

### Movement Control Example of Vehicle 10

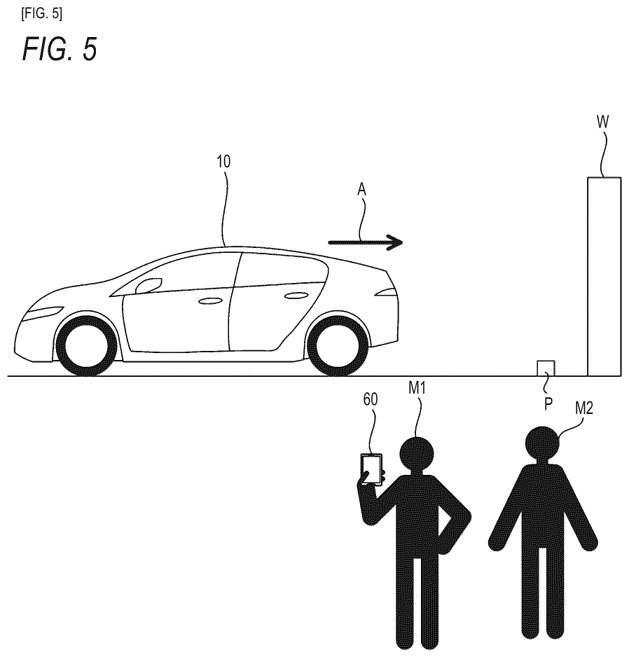

An example of the movement control for moving the vehicle 10 to the target movement position will be described with reference to FIGS. 5 to 9.

FIGS. 5 to 9 show key steps to perform wireless communication with the calculation unit 52 of the vehicle 10 by a user M1 using the information terminal 60 from the outside of the vehicle 10 and to cause the vehicle 10 to perform automated parking at the predetermined parking position.

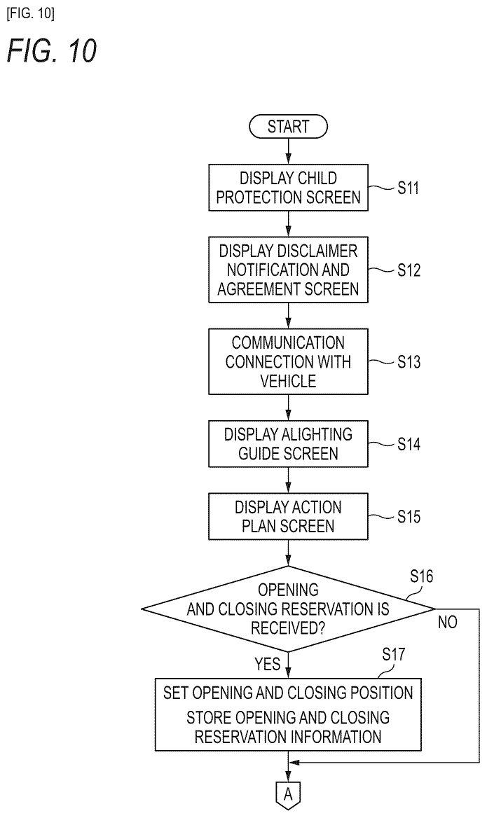

For example, it is assumed that the user M1 is a driver of the vehicle 10 and a user M2 is a passenger. The users M1 and M2 load luggage into the rear luggage compartment of the vehicle 10 and plan to unload the luggage from the rear luggage compartment. In this case, the user M1 may perform an “opening and closing reservation” of the opening and closing body, which indicates that a tail gate is to be opened and closed in order to unload the luggage in the rear luggage compartment, by using the information terminal 60. The opening and closing reservation is performed, for example, before movement of the vehicle 10 by automated parking is started. When the opening and closing reservation is performed, the information terminal 60 transmits opening and closing reservation reception information to the vehicle 10. The opening and closing reservation of the opening and closing body will be described in detail with reference to FIG. 10 and subsequent drawings.

When the automated parking control unit 55 receives the opening and closing reservation reception information from the information terminal 60, the vehicle 10 calculates, based on the received opening and closing reservation reception information, the appropriate opening and closing position of the opening and closing body for opening and closing the opening and closing body. In the present example shown in the drawing, since the tail gate is opened and closed in order to unload the luggage, the appropriate opening and closing position for opening and closing the tail gate is calculated. At this time, the obstacle detection unit 57 of the vehicle 10 determines whether there is any obstacle in a parking route of the vehicle 10 during the automated parking. In the shown present example, the obstacle detection unit 57 detects a wall W behind a parking curb P and determines that the wall W is an obstacle located around the target parking position. When the wall W is detected as the obstacle, the automated parking control unit 55 calculates the appropriate opening and closing position for opening and closing the tail gate with respect to the wall W that is present.

Here, in order to start the automated parking of the vehicle 10, the user M1 operates the information terminal 60. The information terminal 60 transmits, to the vehicle 10, a parking instruction signal for causing the vehicle 10 to perform automated parking in response to the operation on the information terminal 60 by the user M1.

As shown in FIG. 5, when the parking instruction signal is received from the information terminal 60, the automated parking control unit 55 of the vehicle 10 starts movement execution control for causing the vehicle 10 to perform automated parking at the predetermined parking position based on the received parking instruction signal. Accordingly, for example, the vehicle 10 starts moving backward in a direction of an arrow A toward the parking curb P (the feature of the parking space) serving as the target parking position.

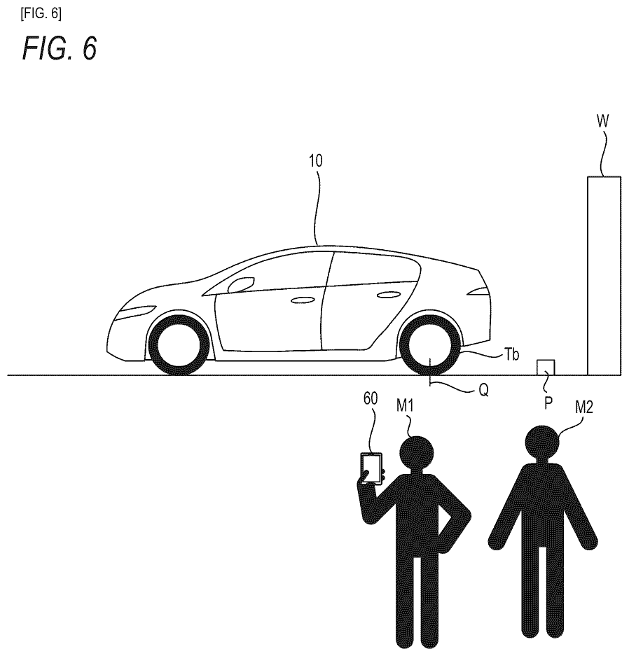

As described above, in the automated parking of the present example shown in the drawing, the luggage is planned to be unloaded from the rear luggage compartment, and the opening and closing reservation of the tail gate is performed. The wall W behind the parking curb P is detected as the obstacle located around the target parking position. Therefore, as shown in FIG. 6, the information terminal 60 temporarily stops the movement of the vehicle 10 during the automated parking at the appropriate opening and closing position for opening and closing the tail gate calculated with respect to the wall W that is present. Specifically, the information terminal 60 stops the vehicle 10 at a position Q that is a position at which a rear wheel Tb of the vehicle 10 does not reach the position of the parking curb P and at which the user is able to open the tail gate to smoothly unload the luggage from the rear luggage compartment.

Next, in order to open the tail gate of the vehicle 10, the user M1 operates the information terminal 60. The information terminal 60 transmits, to the vehicle 10, an opening instruction signal for opening the tail gate of the vehicle 10 in response to the operation on the information terminal 60 by the user M1.

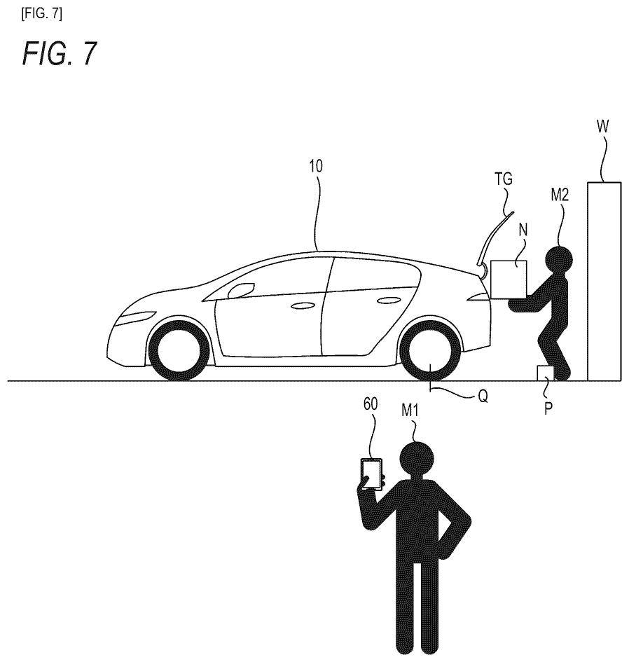

As shown in FIG. 7, when the opening instruction signal is received from the information terminal 60, the opening and closing control unit 56 of the vehicle 10 controls the opening and closing drive unit 40 to open a tail gate TG of the vehicle 10 based on the received opening instruction signal. Accordingly, the tail gate TG of the vehicle 10 is opened, and for example, luggage N is unloaded from the rear luggage compartment by the user M2.

Next, when the luggage N is carried out from the vehicle 10, the user M1 operates the information terminal 60 to close the tail gate TG. The information terminal 60 transmits, to the vehicle 10, a closing instruction signal for closing the tail gate TG of the vehicle 10 in response to the operation on the information terminal 60 by the user M1.

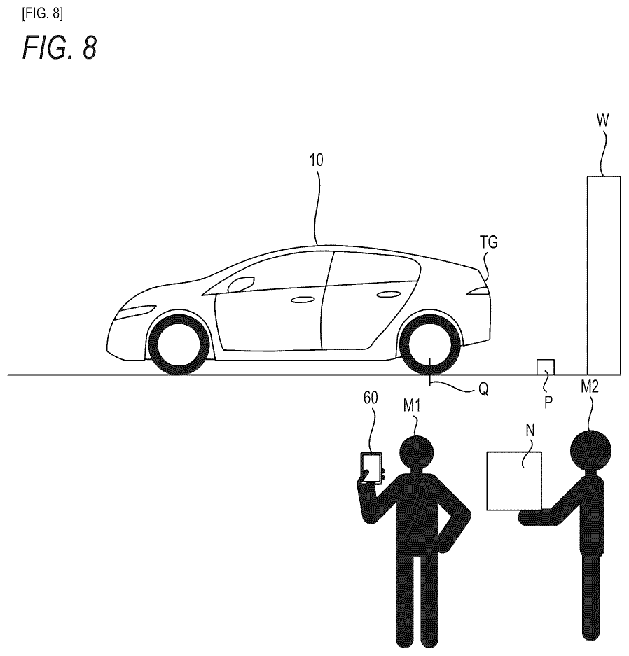

As shown in FIG. 8, when the closing instruction signal is received from the information terminal 60, the opening and closing control unit 56 of the vehicle 10 controls the opening and closing drive unit 40 to close the tail gate TG of the vehicle 10 based on the received closing instruction signal. Accordingly, the tail gate TG of the vehicle 10 is closed, and the processing of unloading the luggage N from the rear luggage compartment is completed.

Next, in order to resume the automated parking of the vehicle 10, the user M1 operates the information terminal 60. The information terminal 60 transmits, to the vehicle 10, a parking resume instruction signal for resuming the automated parking of the vehicle 10 in response to the operation on the information terminal 60 by the user M1.

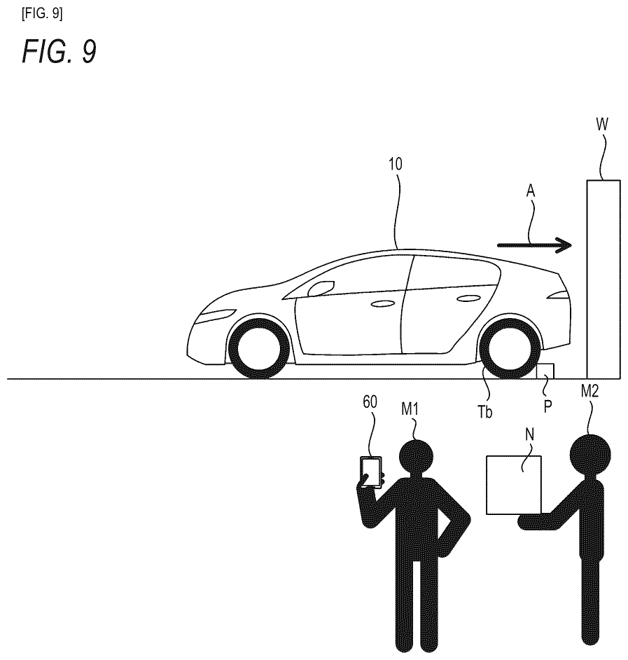

As shown in FIG. 9, when the parking resume instruction signal is received from the information terminal 60, the automated parking control unit 55 of the vehicle 10 resumes the movement execution control for causing the vehicle 10 to perform automated parking at the predetermined parking position based on the received parking resume instruction signal. Accordingly, the vehicle 10 resumes the movement by moving backward in the direction of the arrow A. The automated parking control unit 55 stops the movement when the vehicle 10 reaches the position of the parking curb P that is the target parking position. The automated parking control unit 55 transmits, to the information terminal 60, a movement completion signal indicating that the vehicle 10 is parked at the target parking position, and ends the movement execution control of the automated parking.

Upon receiving the movement completion signal from the vehicle 10, the information terminal 60 ends the parking instruction control of the automated parking for causing the vehicle 10 to park at the target parking position.

### <Specific Movement Instruction Control by Information Terminal 60>

Next, an example of the movement instruction control of the vehicle 10 by the processor 81 of the information terminal 60 will be described with reference to FIGS. 10 to 22.

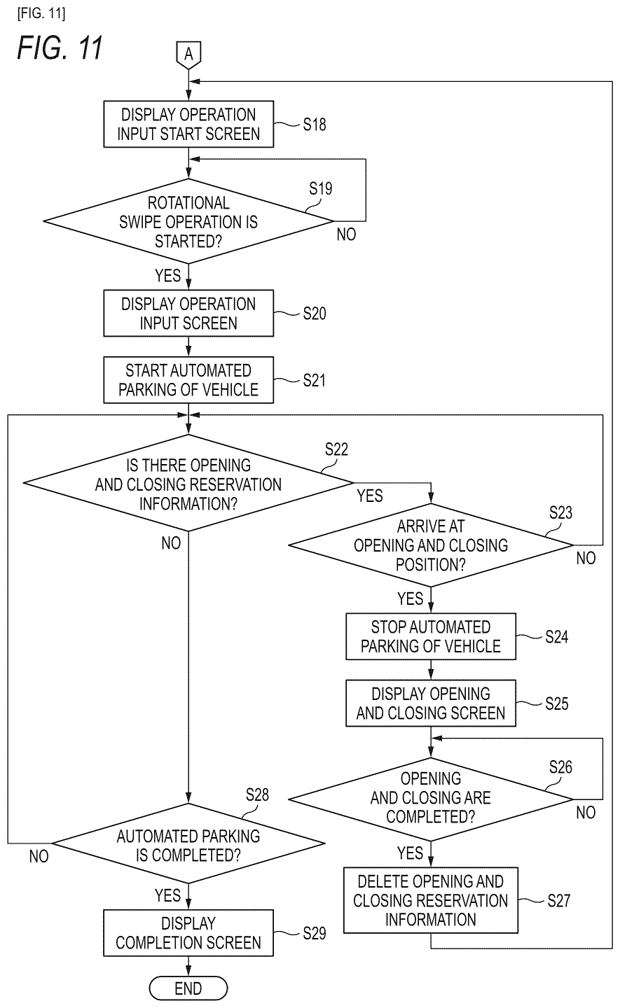

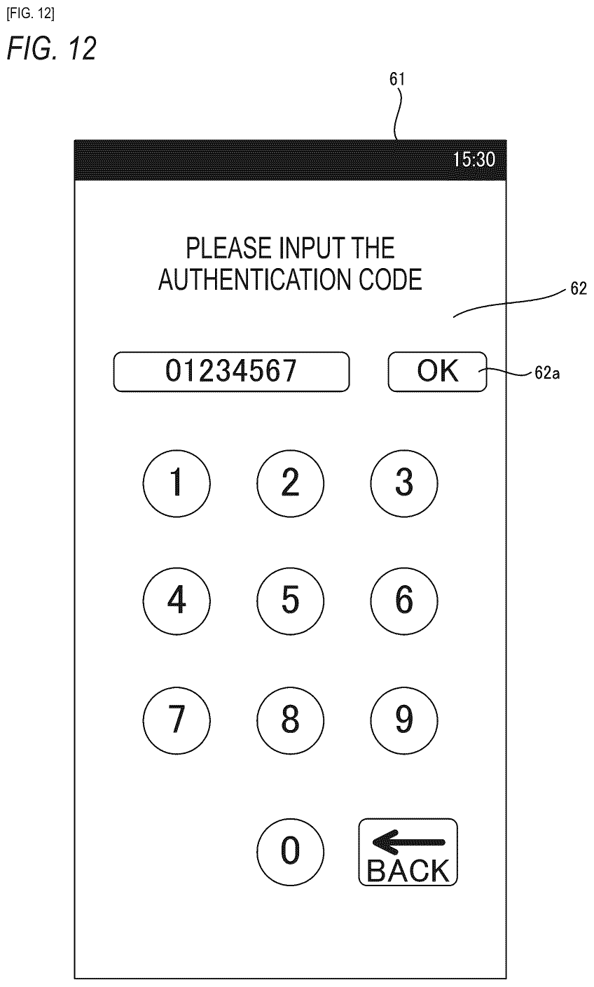

FIGS. 10 and 11 are flowcharts showing the parking instruction control of the vehicle 10 by the processor 81 of the information terminal 60. FIGS. 12 to 22 show examples of images displayed on a terminal screen 61 of the information terminal 60 that performs the parking instruction control on the vehicle 10.

For example, the vehicle 10 is caused to perform automated parking in a vacant parking space in a parking lot where the user M1 who drives the vehicle 10 is located. When an automated parking button (not shown) displayed on the touch panel 42 of the navigation device 18 is touched by the user M1, a top view image of a surrounding area of the vehicle 10 acquired by the front camera 12Fr, the rear camera 12Rr, the left side camera 12L, and the right side camera 12R is displayed on the touch panel 42. Further, when the user M1 selects, on the touch panel 42, the parking space for parking the vehicle 10, the automated parking control unit 55 of the vehicle 10 receives the selection of the parking space.

For example, the user M1 gets off the vehicle 10 while carrying the information terminal 60, and launches an automated parking application software installed in the information terminal 60 in order to cause the vehicle 10 to perform automated parking. Processing shown in FIG. 6 is started when the automated parking application software in the information terminal 60 is launched.

For example, the processor 81 displays a child protection screen 62 as shown in FIG. 12 on the terminal screen 61 of the information terminal 60 (step S11). After a predetermined authentication code is input to the child protection screen 62 by the user M1, an OK button 62a is touched.

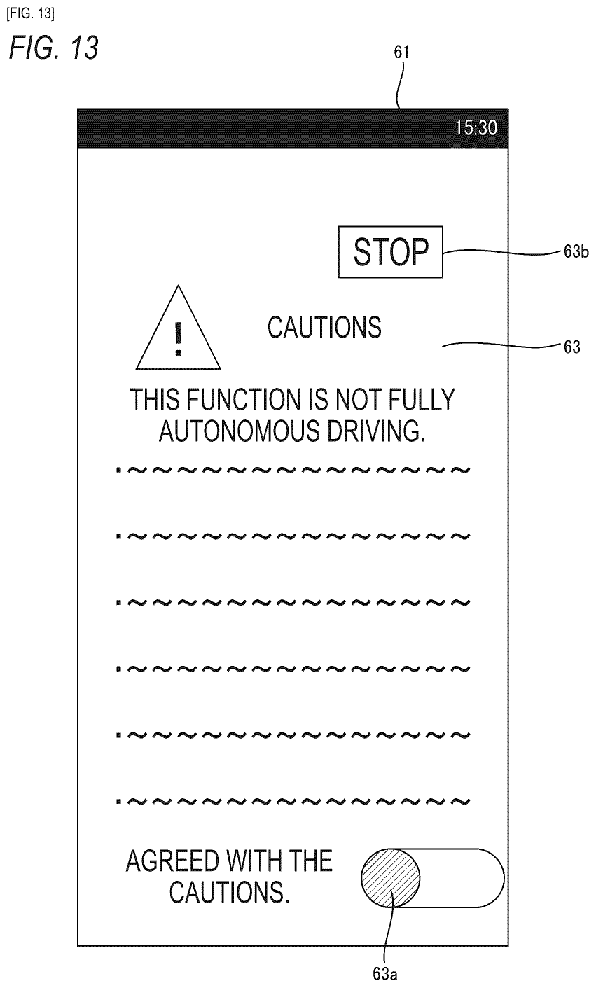

When the OK button 62a is touched in step S11, for example, as shown in FIG. 13, the processor 81 displays, on the terminal screen 61, a disclaimer notification and agreement screen 63 stipulated for automated parking (step S12). When contents of the disclaimer notification and agreement screen 63 are agreed with, a swipe operation is performed on an agreement button 63a, and when the contents are not agreed with, a stop button 63b for stopping the automated parking is touched.

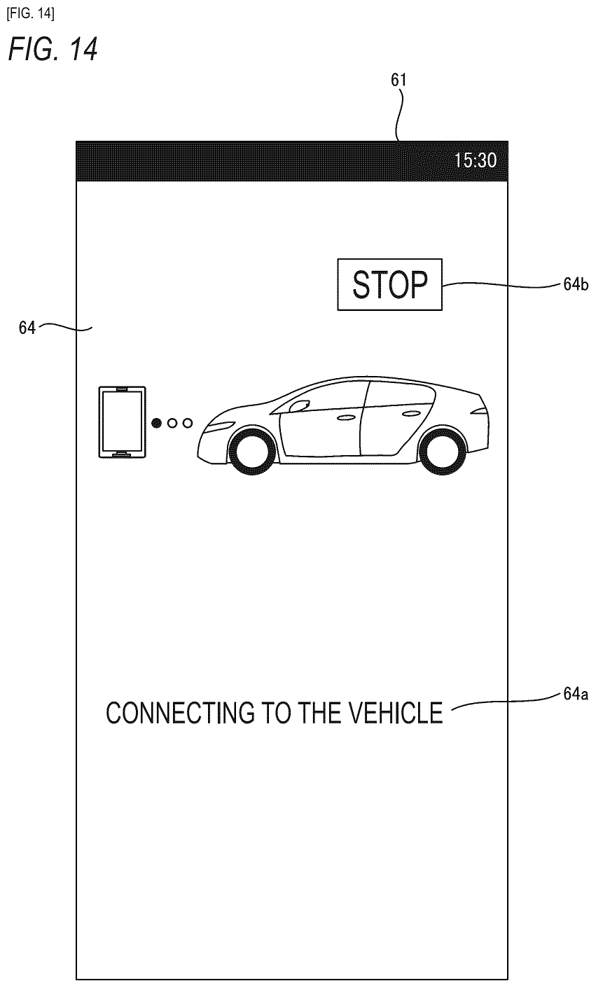

When the agreement button 63a is operated in step S12, the processor 81 starts processing of communication connection with the vehicle 10, and displays, for example, a connection screen 64 as shown in FIG. 14 on the terminal screen 61 (step S13). The processor 81 displays, on the connection screen 64, a connection message 64a indicating that connection processing with the vehicle 10 is being performed, such as “connecting to the vehicle”, and a stop button 64b for stopping the connection processing.

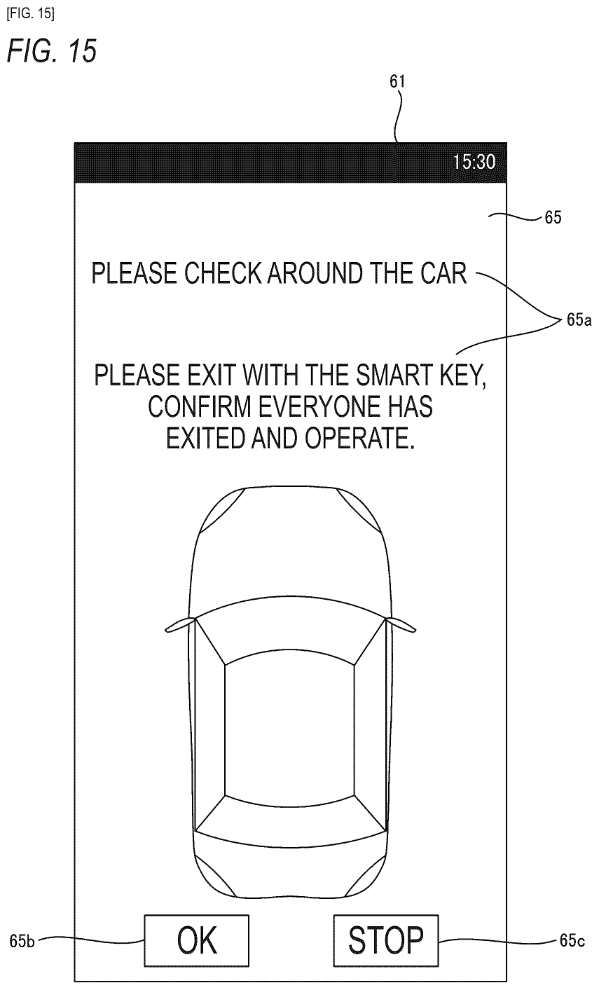

When the communication connection with the vehicle 10 in step S13 is completed, the processor 81 displays, on the terminal screen 61, for example, an alighting guide screen 65 as shown in FIG. 15 (step S14). The processor 81 displays, on the alighting guide screen 65, a confirmation message 65a that prompts the user to get off the vehicle 10 and prompts the user to perform a next operation, such as “please check around the vehicle, exit with the smart key, confirm everyone has exited and operate”. The processor 81 also displays, on the alighting guide screen 65, an OK button 65b indicating confirmation of the confirmation message 65a and a stop button 65c for stopping the operation.

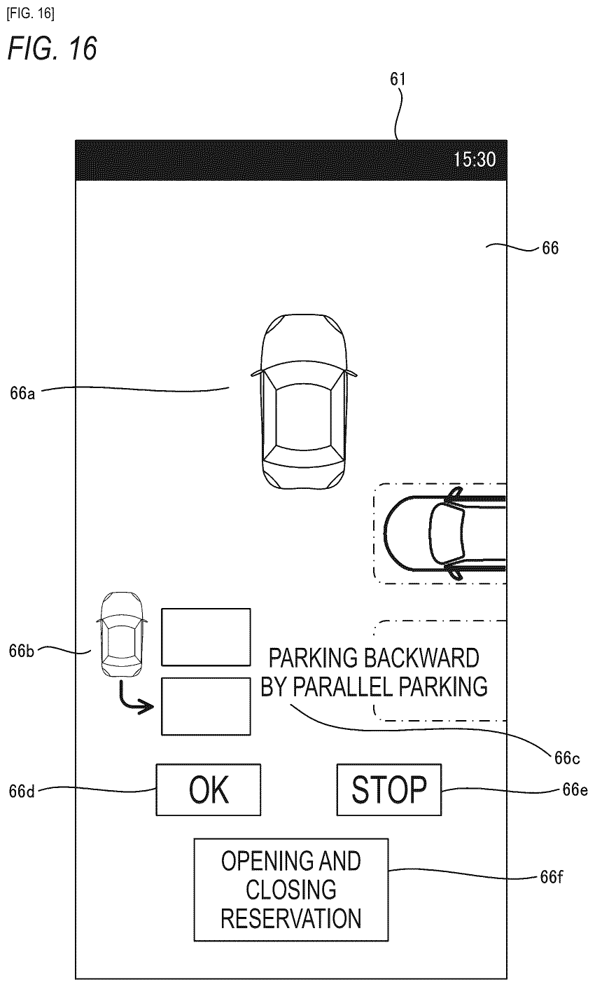

When the OK button 65b is touched in step S14, the processor 81 displays, on the terminal screen 61, for example, a first action plan screen 66 as shown in FIG. 16 (step S15). The processor 81 displays, on the first action plan screen 66, a top view image 66a of the surrounding area of the vehicle 10 received from the vehicle 10 and a planned parking image 66b indicating the parking space of the vehicle 10 received from the vehicle 10. A parking message 66c such as “parking backward by parallel parking” may be added to the planned parking image 66b. The processor 81 also displays, on the first action plan screen 66, an OK button 66d indicating that automated parking may be started according to this content, and a stop button 66e for stopping the automated parking. Further, the processor 81 displays an opening and closing reservation button 66f for performing the opening and closing reservation of the opening and closing body on the first action plan screen 66.

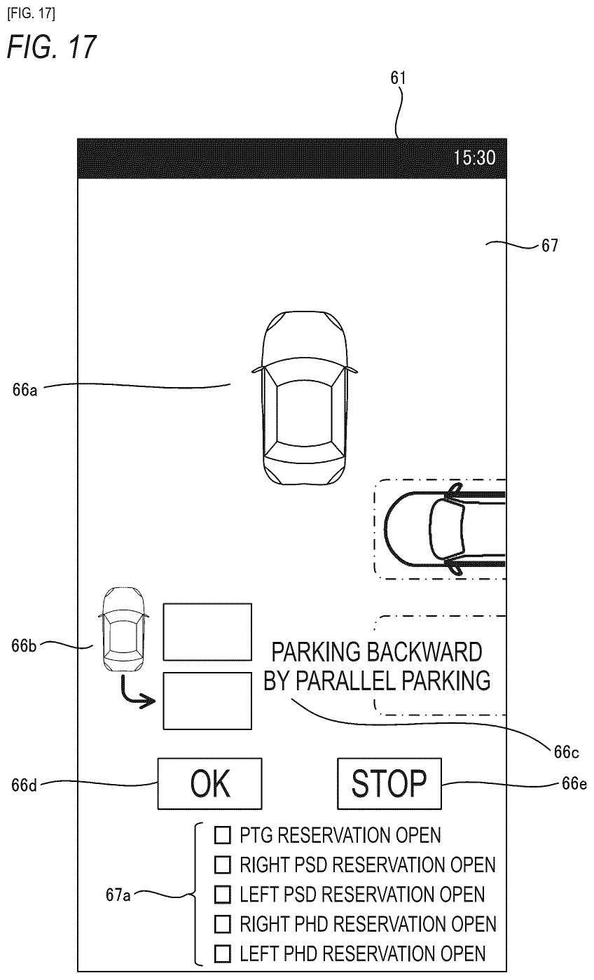

When the opening and closing reservation button 66f is touched on the first action plan screen 66, the processor 81 displays, on the terminal screen 61, for example, a second action plan screen 67 as shown in FIG. 17. On the second action plan screen 67, opening and closing reservation items 67a are displayed instead of the opening and closing reservation button 66f in a display space of the opening and closing reservation button 66f on the first action plan screen 66 shown in FIG. 16. The opening and closing reservation items 67a include, for example, “PTG reservation OPEN” for reserving opening and closing of the tail gate, “right PSD reservation OPEN” for reserving opening and closing of a right slide door, “left PSD reservation OPEN” for reserving opening and closing of a left slide door, “right PHD reservation OPEN” for reserving opening and closing of a right hinge door, and “left PHD reservation OPEN” for reserving opening and closing of a left hinge door.

Next, the processor 81 determines whether the opening and closing reservation of the opening and closing body is received (step S16). For example, when the OK button 66d is touched after at least one opening and closing reservation item 67a (check box) is checked on the second action plan screen 67 shown in FIG. 17, the processor 81 determines that the opening and closing reservation of the opening and closing body is received. On the other hand, for example, when the OK button 66d is touched without checking any one of the opening and closing reservation items 67a on the second action plan screen 67 shown in FIG. 17, or when the OK button 66d is touched without touching the opening and closing reservation button 66f on the first action plan screen 66 shown in FIG. 16, the processor 81 determines that the opening and closing reservation of the opening and closing body is not received.

In step S16, when the opening and closing reservation is received (step S16: Yes), the processor 81 sets the opening and closing position of the opening and closing body for which the opening and closing reservation is performed, and stores the opening and closing reservation information including the set opening and closing position in the memory 82 (step S17).

Specifically, in step S17, the processor 81 transmits the received opening and closing reservation reception information to the vehicle 10.

When the opening and closing reservation reception information is received from the information terminal 60, the automated parking control unit 55 of the vehicle 10 calculates the appropriate opening and closing position of the opening and closing body for opening and closing the reserved opening and closing body based on the received opening and closing reservation reception information. Here, for example, it is assumed that the opening and closing body subjected to the opening and closing reservation is the “tail gate TG”. As described above, the appropriate opening and closing position for opening and closing the tail gate TG is the position at which the tail gate TG may be smoothly opened and closed whereas the luggage N may be smoothly taken out when the luggage Nis unloaded from the rear luggage compartment. The calculation of the opening and closing position is affected by presence or absence of an obstacle around the vehicle 10. Therefore, the automated parking control unit 55 calculates the appropriate opening and closing position for opening and closing the tail gate TG in consideration of the presence or absence of the obstacle. The automated parking control unit 55 stores the calculated opening and closing position of the tail gate TG and the opening and closing reservation reception information received from the information terminal 60 in the storage unit 54. Then, the automated parking control unit 55 transmits the calculated opening and closing position of the tail gate TG to the information terminal 60.

When the opening and closing position of the tail gate TG is received from the vehicle 10, the processor 81 of the information terminal 60 sets the received opening and closing position of the tail gate TG as opening and closing position information of the present processing for causing the vehicle 10 to perform the automated parking. The processor 81 stores, in the memory 82, the received opening and closing reservation information including the opening and closing position of the tail gate TG.

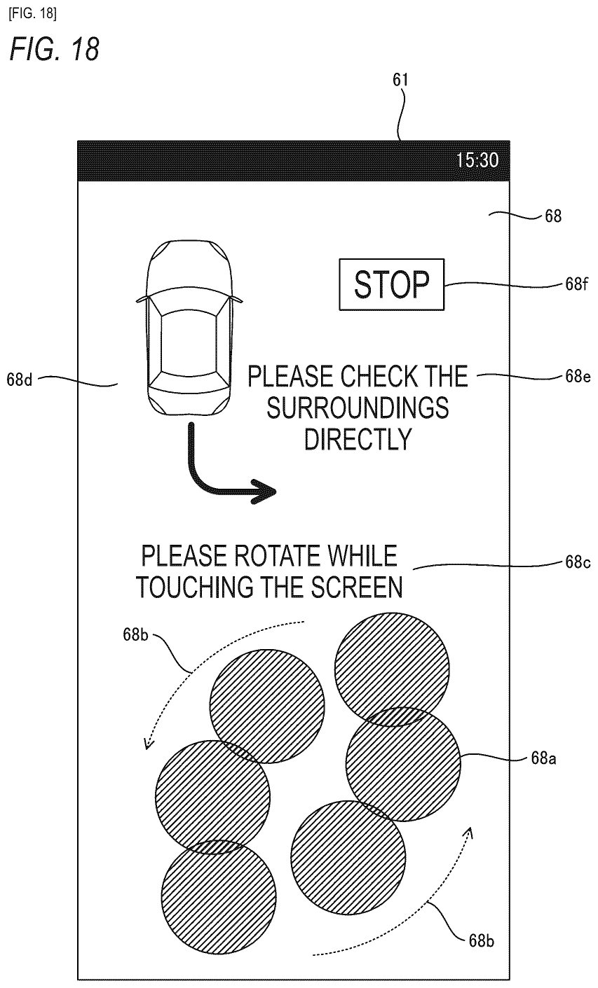

Next, the processing proceeds to step S18, and for example, as shown in FIG. 18, the processor 81 displays, on the terminal screen 61, an operation input start screen 68 for guiding the start of the automated parking (step S18). The processor 81 displays, on the operation input start screen 68, for example, an image in which six spheres 68a perform left rotation in a direction indicated by an arrow 68b. That is, an image for prompting a rotational swipe operation of sliding counterclockwise on the terminal screen 61 is displayed. The processor 81 also displays, on the operation input start screen 68, for example, a guidance message 68c such as “please rotate while touching the screen”. The processor 81 displays, on the operation input start screen 68, a vehicle image 68d indicating that the vehicle 10 is parked backward and an attention calling message 68e such as “please check the surroundings directly”. Further, the processor 81 displays a stop button 68f for stopping the automated parking on the operation input start screen 68.

On the other hand, in step S16, when the opening and closing reservation is not received (step S16: No), the processor 81 proceeds to step S18 directly and displays the operation input start screen 68 shown in FIG. 18 on the terminal screen 61.

Next, the processor 81 determines whether the rotational swipe operation is started on the terminal screen 61 (step S19).

In step S19, when the rotational swipe operation is not started (step S19: No), the processor 81 repeats the processing of step S19 and stands by until the rotational swipe operation is started.

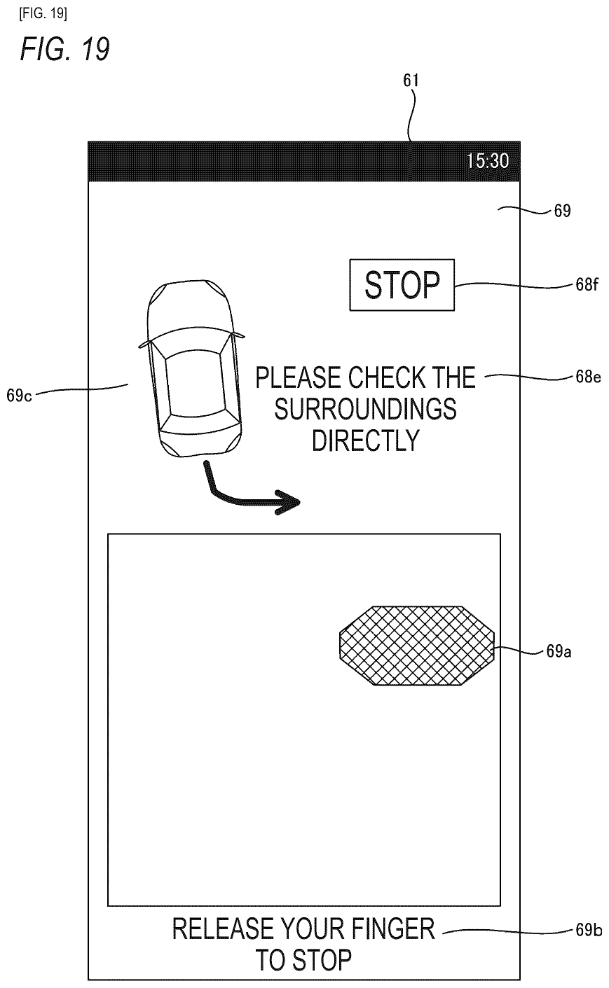

In step S19, when the rotational swipe operation is started (step S19: Yes), for example, as shown in FIG. 19, the processor 81 displays, on the terminal screen 61, an operation input screen 69 indicating a state in which the rotational swipe operation is performed (step S20). The processor 81 displays, on the operation input screen 69, for example, a movement icon 69a that moves following a touch position of the user M1 during the rotational swipe operation. The processor 81 also displays a guidance message 69b for stopping the automated parking of the vehicle 10, such as “release your finger to stop”. The processor 81 displays, on the operation input screen 69, a vehicle image 69c indicating that the vehicle 10 is parking backward, and the attention calling message 68e and the stop button 68f as in FIG. 18. In this way, when the rotational swipe operation is performed on the terminal screen 61, the movement icon 69a rotationally moves following the touch position, and the vehicle 10 moves according to the rotational movement. When a finger performing the rotational swipe operation is released from the terminal screen 61 or when the rotational swipe operation is stopped, the movement of the automated parking of the vehicle 10 is temporarily stopped.

Next, the processor 81 starts automated parking of the vehicle 10 by transmitting the parking instruction signal to the vehicle 10 (step S21). When the parking instruction signal is received from the information terminal 60, the automated parking control unit 55 of the vehicle 10 starts the automated parking of the vehicle 10 according to the received parking instruction signal.

Next, the processor 81 determines whether there is any opening and closing reservation information of the opening and closing body in the automated parking currently performed (step S22).

In step S22, when there is the opening and closing reservation information (step S22: Yes), the processor 81 determines whether the vehicle 10 performing the automated parking arrives at the appropriate opening and closing position for opening and closing the tail gate TG (step S23).

In step S23, when the vehicle 10 does not arrive at the appropriate opening and closing position for opening and closing the tail gate TG (step S23: No), the processor 81 returns to step S22 and repeats processing of each step.

In step S23, when the vehicle 10 arrives at the appropriate opening and closing position for opening and closing the tail gate TG (step S23: Yes), the processor 81 temporarily stops the automated parking being performed at the opening and closing position (step S24).

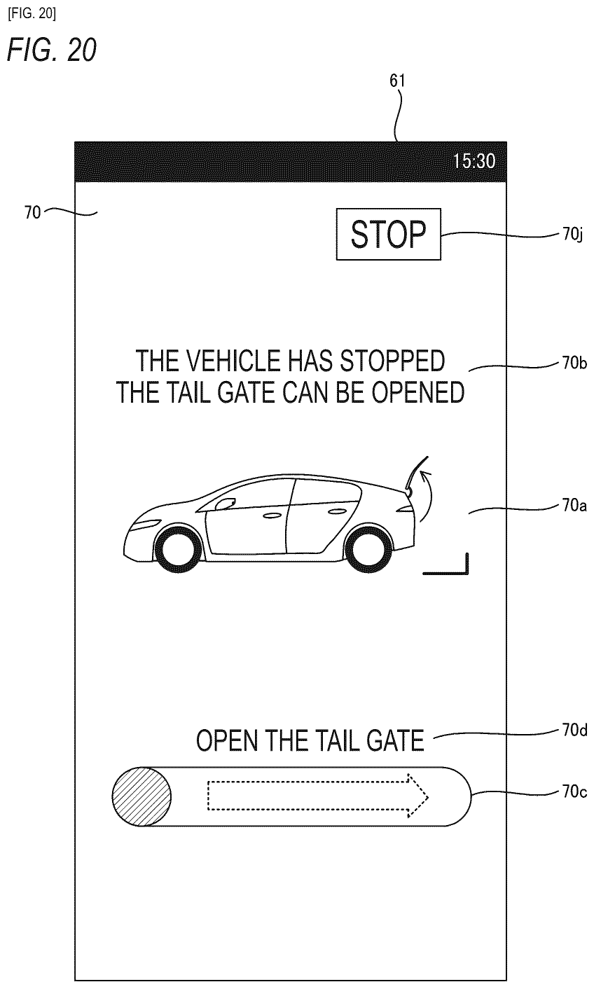

Next, for example, as shown in FIG. 20, the processor 81 displays an opening and closing screen 70 for guiding opening and closing of the tail gate TG on the terminal screen 61 (step S25). When the tail gate TG is to be opened, the processor 81 displays, on the opening and closing screen 70, for example, a vehicle image 70a of the vehicle 10 that stops at the appropriate opening and closing position for opening and closing the tail gate TG, and a guidance message 70b such as “the vehicle has stopped, and the tail gate can be opened”. The processor 81 also displays, on the opening and closing screen 70, an opening operation image 70c that prompts a swipe operation for opening the tail gate TG and a guidance message 70d such as “open the tail gate”. When the opening operation image 70c is swiped rightward, the processor 81 opens the tail gate TG.

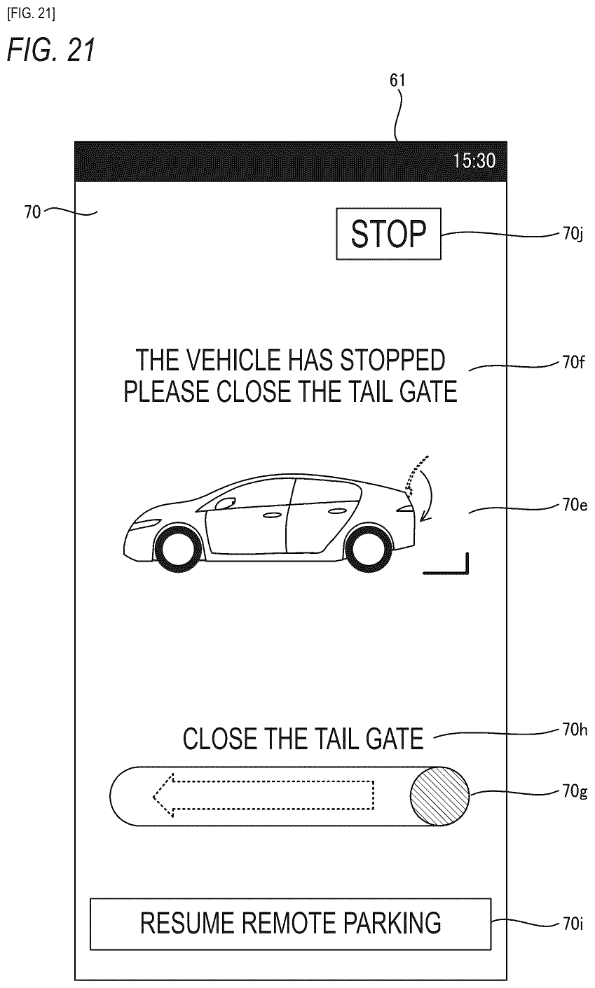

When the tail gate TG is to be closed, for example, as shown in FIG. 21, the processor 81 displays, on the opening and closing screen 70, a vehicle image 70e of the vehicle 10 that stops at the opening and closing position with the tail gate TG being closed, and a guidance message 70f such as “please close the tail gate.”. The processor 81 also displays, on the opening and closing screen 70, a closing operation image 70g that prompts a swipe operation for closing the tail gate TG, and a guidance message 70h such as “close the tail gate”. When the closing operation image 70g is swiped leftward, the processor 81 closes the tail gate TG.

The processor 81 displays, on the opening and closing screen 70, a parking resume button 70i for resuming the remote parking after unloading of the luggage N from the rear luggage compartment is completed and the tail gate TG is closed. Further, the processor 81 displays, on the opening and closing screen 70, a stop button 70j for stopping the automated parking.

Next, the processor 81 determines whether the opening and closing of the tail gate TG are completed, that is, whether unloading of the luggage N from the rear luggage compartment is completed (step S26). The opening and closing of the tail gate TG are determined to be completed, for example, when the parking resume button 70i is touched after the unloading of the luggage N from the rear luggage compartment is completed and the tail gate TG is closed.

In step S26, when the opening and closing of the tail gate TG are not completed (step S26: No), the processor 81 stands by until the opening and closing are completed.

In step S26, when the opening and closing of the tail gate TG are completed (step S26: Yes), the processor 81 deletes the opening and closing reservation information of the opening and closing body in the automated parking being performed (step S27), returns the processing to step S18, and repeats each piece of processing.

Accordingly, in step S18 to step S21, when the rotational swipe operation is resumed, the processor 81 resumes the automated parking of the vehicle 10. Since the opening and closing reservation information is deleted in step S27, the processor 81 proceeds to the processing of step S28 in branch processing of step S22.

In step S22, when there is no opening and closing reservation information (step S22: No), the processor 81 determines whether the automated parking is completed, that is, whether parking of the vehicle 10 into the parking space selected by the user M1 is completed (step S28). Whether the automated parking is completed may be determined based on information about execution control transmitted from the automated parking control unit 55 of the vehicle 10.

In step S28, when the automated parking is not completed (step S28: No), the processor 81 returns the processing to step S22 and repeats the processing of each step.

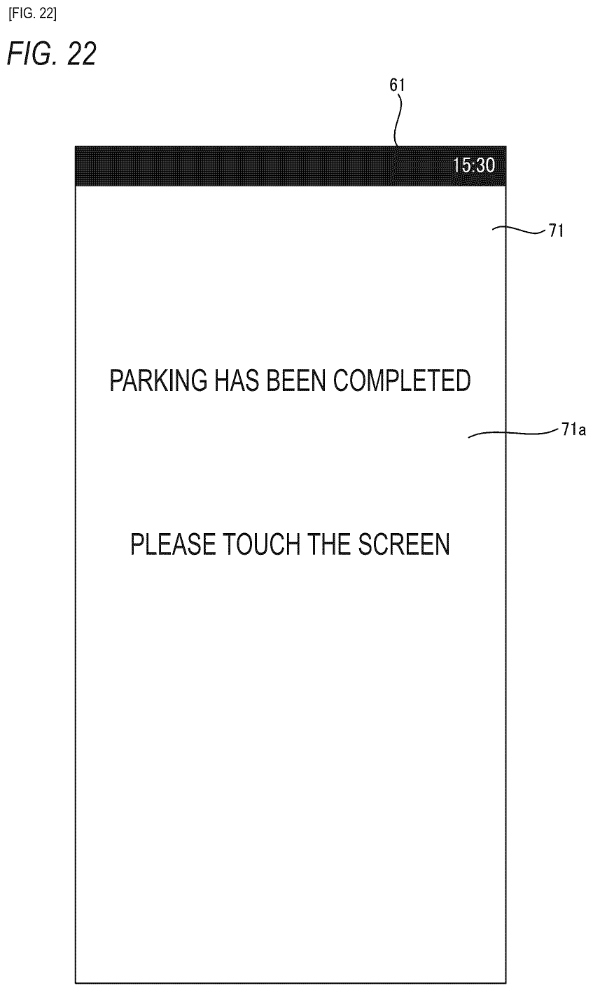

In step S28, when the automated parking is completed (step S28: Yes), the processor 81 displays, on the terminal screen 61, for example, an automated parking completion screen 71 as shown in FIG. 22 (step S29). The processor 81 displays, on the automated parking completion screen 71, for example, a parking completion message 71a such as “parking has been completed, please touch the screen”. Accordingly, when the terminal screen 61 is touched, the automated parking application software is terminated.

In the automated parking of the vehicle 10, even when presence of an obstacle around the vehicle 10 cannot be detected at a start stage of the automated parking, the obstacle may be detected during the automated parking. In this case, the processor 81 may reset the appropriate opening and closing position for opening and closing the tail gate TG based on the obstacle detected during the automated parking and update the opening and closing reservation information. For example, when it is determined in step S25 that the vehicle 10 does not arrive at the opening and closing position yet and the processing of returning to step S22 is performed, that is, when an obstacle is detected during the automated parking, the processor 81 may reset the opening and closing position of the tail gate TG in consideration of whether the obstacle obstructs the opening and closing of the tail gate TG. The processor 81 may store the opening and closing reservation information including the reset opening and closing position in the memory 82.

As described above, when the opening and closing reservation of the tail gate TG (opening and closing body) is performed, the processor 81 of the information terminal 60 stops the vehicle 10 at the opening and closing position which is a position different from the target parking position and is appropriate for opening and closing the tail gate TG after the start of the automated parking for moving the vehicle 10 to the target parking position, performs the opening and closing of the tail gate TG, and resumes the movement of the vehicle 10 to the target parking position after the opening and closing are completed. Accordingly, by performing the opening and closing reservation of the tail gate TG (opening and closing body), the vehicle 10 may be temporarily stopped at the appropriate opening and closing position for opening and closing the tail gate TG before reaching the target parking position of the vehicle 10, the opening and closing of the tail gate TG may be performed, and the automated parking of the vehicle 10 may be resumed after the opening and closing. Therefore, for example, the vehicle 10 may be stopped at a place where the tail gate TG may be easily opened and closed in the middle of the automated parking, the luggage N may be unloaded from the rear luggage compartment, and the automated parking may be continued after unloading of the luggage N is completed, thereby improving usability.

When an obstacle is detected around the vehicle 10, the processor 81 of the information terminal 60 sets the appropriate opening and closing position for opening and closing the tail gate TG in consideration of an influence of the obstacle on the opening and closing of the tail gate TG. Accordingly, it is possible to prevent a situation in which the opening and closing of the tail gate TG cannot be performed due to the obstacle, and it is possible to set an optimum opening and closing position of the tail gate TG.

When the vehicle 10 is stopped at the appropriate opening and closing position for opening and closing the tail gate TG, the processor 81 of the information terminal 60 displays, on the terminal screen 61, notification for prompting opening and closing of the tail gate TG. Accordingly, the user M1 may grasp an opening and closing timing of the tail gate TG, and thus usability is improved.

The processor 81 of the information terminal 60 causes the vehicle 10 to open and close the tail gate TG when an instruction to open and close the tail gate TG is received from the user M1 after the notification for prompt opening and closing of the tail gate TG. Accordingly, since the tail gate TG may be opened and closed according to the user M1's will, usability may be improved.

The processor 81 of the information terminal 60 may perform the opening and closing on an opening and closing body for which the opening and closing reservation is performed by the user M1 among a plurality of opening and closing bodies, and thus usability may be improved.

The processor 81 of the information terminal 60 allows the movement control of the vehicle 10 and the opening and closing reservation of the opening and closing body to be performed remotely based on an input operation on the information terminal 60 carried by the user M1. Therefore, for example, as compared to a case where the user M1 gets on the vehicle 10 and performs the movement control of the vehicle 10 and the opening and closing reservation of the opening and closing body by operating an in-vehicle operation unit, it is possible to reduce an operation burden on the user M1 and improve usability.

Although the embodiment of the present invention has been described above, the present invention is not limited to the above-described embodiment, and modifications, improvements, and the like may be appropriately made.

For example, in the above-described embodiment, the case where the vehicle 10 performs automated parking is described, and the same control may be performed when the vehicle 10 performs automated exiting. In the case of the automated exiting, for example, when it is planned to open the tail gate TG and load the luggage N into the rear luggage compartment, the opening and closing reservation is performed before the automated exiting is started. In this case, the processor 81 performs control such that the vehicle 10 is moved by the automated exiting to a place where the user M1 is located, and when the tail gate TG cannot be smoothly opened and closed or the luggage N cannot be smoothly loaded if the vehicle 10 is moved to the place where the user M1 is located, the vehicle 10 is stopped at a place slightly before the place where the user M1 is located or a place slightly after the place where the user M1 is located. Accordingly, it is possible to smoothly open and close the tail gate TG and load the luggage N.

In the above-described embodiment, the case where the opening and closing of the opening and closing body (for example, the tail gate TG) is automatically performed by operating the information terminal 60 is described, but the invention is not limited thereto. For example, the opening and closing body may be manually opened and closed by the users M1 and M2.

In the above-described embodiment, the opening and closing of the tail gate TG are described as an example of the opening and closing of the opening and closing body, but the opening and closing of the opening and closing body are not limited thereto. The opening and closing of the opening and closing body may be, for example, processing for enabling manual opening and closing of the opening and closing body. Specifically, the processing may be unlocking of the opening and closing body. The opening and closing of the opening and closing body may be, for example, processing of displaying guidance information about the opening and closing body on the terminal screen 61 of the information terminal 60.

In the above-described embodiment, the case where the user M1 gets off the vehicle and performs automated parking and automated exiting using the information terminal 60 10 from the outside of the vehicle 10 is described, but the invention is not limited thereto. For example, the automated parking and the automated exiting may be performed using the information terminal 60 from inside the vehicle 10 while the user M1 is located in the vehicle 10.

In the above-described embodiment, the case where the information terminal 60 as an example of the control device instructs movement control of the vehicle 10 is described, but the control device is not limited thereto. For example, a vehicle-mounted device mounted on the vehicle 10 may be an example of the control device, and the vehicle-mounted device may instruct movement control of the vehicle 10. Further, a combination of the information terminal 60 and the vehicle-mounted device may be an example of the control device, and the information terminal 60 and the vehicle-mounted device may cooperate to instruct movement control of the vehicle 10.

In the above-described embodiment, an example in which the moving object is a vehicle (four-wheeled automobile) has been described, but the moving object is not limited thereto. For example, the moving object may be a vehicle such as a motorcycle or a Segway. Further, the idea of the present invention is not limited to the vehicle, and may also be applied to a robot, a ship, an aircraft, or the like that includes a drive source and is movable by power of the drive source.

The control method described in the above embodiment may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements or the like in the embodiment described above are shown in parentheses, the present invention is not limited thereto.
(1) A control device (information terminal 60) for a moving object (vehicle 10) that includes an opening and closing body (tail gate TG), the control device including:
   a control unit (processor 81) configured to perform movement control for moving the moving object to a target movement position, in which,
   in response to an opening and closing reservation of the opening and closing body being performed, the control unit stops the moving object at an opening and closing position different from the target movement position after the movement control is started, performs opening and closing of the opening and closing body, and resumes movement of the moving object toward the target movement position after the opening and closing are completed.

According to (1), by performing the opening and closing reservation of the opening and closing body, the opening and closing body may be subjected to opening and closing by stopping the moving object before reaching the target movement position, thus the movement control may be performed according to a request of the user, and usability is improved.
(2) The control device according to (1), in which
   the opening and closing position is a position midway along a route to the target movement position.

According to (2), the opening and closing body may be opened and closed before reaching the target movement position, and thus usability is improved.
(3) The control device according to (1) or (2), in which
   the opening and closing position is set based on a detection result of an obstacle around the moving object.

According to (3), it is possible to prevent a situation in which the opening and closing body cannot be opened and closed due to an obstacle, and it is possible to set an optimum opening and closing position.
(4) The control device according to any one of (1) to (3), in which,
   in response to the moving object being stopped at the opening and closing position, the control unit performs notification to prompt a user of the moving object to open and close the opening and closing body.

According to (4), the user may grasp an opening and closing timing of the opening and closing body, and thus usability is improved.
(5) The control device according to (4), in which,
   in response to an instruction to open and close the opening and closing body being received from the user of the moving object after the notification, the control unit causes the opening and closing body to open and close.

According to (5), the opening and closing body may be opened and closed according to the user's will, and thus usability is improved.
(6) The control device according to any one of (1) to (5), in which
   the moving object includes a plurality of opening and closing bodies, and the control unit performs the opening and closing on an opening and closing body for which the opening and closing reservation is performed among the plurality of opening and closing bodies.

According to (6), it is possible to perform the opening and closing for the opening and closing body for which the opening and closing reservation is performed by the user, and thus usability is improved.
(7) The control device according to any one of (1) to (6), in which
   the movement control and reception of the opening and closing reservation are performed based on an input operation on an information terminal carried by the user of the moving object.

According to (7), as compared to a case where the user gets on the moving object and performs the movement control and input of the opening and closing reservation, a burden on the user may be reduced by enabling a remote operation, and thus usability is improved.
(8) A control method including:
   causing a processor of a control device that performs movement control for moving a moving object including an opening and closing body to a target movement position to stop, in response to an opening and closing reservation of the opening and closing body being performed, the moving object at an opening and closing position different from the target movement position after the movement control is started, perform opening and closing of the opening and closing body, and resume movement of the moving object toward the target movement position after the opening and closing are completed.

According to (8), by performing the opening and closing reservation of the opening and closing body, the opening and closing body may be subjected to opening and closing by stopping the moving object before reaching the target movement position, thus the movement control may be performed according to a request of the user, and usability is improved.
(9) A control program causing a processor of a control device that performs movement control for moving a moving object including an opening and closing body to a target movement position to execute processing of
   stopping, in response to an opening and closing reservation of the opening and closing body being performed, the moving object at an opening and closing position different from the target movement position after the movement control is started, performing opening and closing of the opening and closing body, and resuming movement of the moving object toward the target movement position after the opening and closing are completed.

According to (9), by performing the opening and closing reservation of the opening and closing body, the opening and closing body may be subjected to opening and closing by stopping the moving object before reaching the target movement position, thus the movement control may be performed according to a request of the user, and usability is improved.

### REFERENCE SIGNS LIST

10 vehicle (moving object)
60 information terminal (control device)
81 processor (control unit)
TG tail gate (opening and closing body)

1. A control device for a moving object that includes an opening and closing body, the control device comprising:
a control unit configured to perform automated movement control for moving the moving object to a target movement position that is a parking position or an exit position, wherein,
in response to an opening and closing reservation of the opening and closing body being performed, the control unit stops the moving object at an opening and closing position different from the target movement position after the automated movement control is started, performs opening and closing of the opening and closing body, and resumes movement of the moving object toward the target movement position after the opening and closing are completed.

2. The control device according to claim 1, wherein
the opening and closing position is a position midway along a route to the target movement position.

3. The control device according to claim 1, wherein
the opening and closing position is set based on a detection result of an obstacle around the moving object.

4. The control device according to claim 1, wherein,
in response to the moving object being stopped at the opening and closing position, the control unit performs notification to prompt a user of the moving object to open and close the opening and closing body.

5. The control device according to claim 4, wherein,
in response to an instruction to open and close the opening and closing body being received from the user of the moving object after the notification, the control unit causes the opening and closing body to open and close.

6. The control device according to claim 1, wherein
the moving object includes a plurality of opening and closing bodies, and
the control unit performs the opening and closing on an opening and closing body for which the opening and closing reservation is performed among the plurality of opening and closing bodies.

7. The control device according to claim 1, wherein
the movement control and reception of the opening and closing reservation are performed based on an input operation on an information terminal carried by the user of the moving object.

8. A control method comprising:
causing a processor of a control device that performs automated movement control for moving a moving object including an opening and closing body to a target movement position that is a parking position or an exit position to
stop, in response to an opening and closing reservation of the opening and closing body being performed, the moving object at an opening and closing position different from the target movement position after the automated movement control is started, perform opening and closing of the opening and closing body, and resume movement of the moving object toward the target movement position after the opening and closing are completed.

9. A non-transitory computer-readable medium storing a control program causing a processor of a control device that performs automated movement control for moving a moving object including an opening and closing body to a target movement position that is a parking position or an exit position to execute processing of
stopping, in response to an opening and closing reservation of the opening and closing body being performed, the moving object at an opening and closing position different from the target movement position after the automated movement control is started, performing opening and closing of the opening and closing body, and resuming movement of the moving object toward the target movement position after the opening and closing are completed.
